(19) United States
(12) Patent Application Publication
(10) Pub. No.: US 2019/0156259 A1
(43) Pub. Date: May 23, 2019

(54) METHODS, SYSTEMS, AND MEDIA FOR CREATING AN ATMOSPHERE SUITED TO A SOCIAL EVENT

(71) Applicant: Google LLC, Mountain View, CA (US)

(72) Inventors: Andrej Cedilnik, Oakland, CA (US); Robert Benea, San Jose, CA (US)

(21) Appl. No.: 16/256,515

(22) Filed: Jan. 24, 2019

Related U.S. Application Data
(63) Continuation of application No. 13/804,130, filed on Mar. 14, 2013.

(51) Int. Cl. G06Q 10/06

(52) U.S. Cl. CPC G06Q 10/06313

(57) ABSTRACT

A method for automatically creating an atmosphere suited to a social event, comprising: determining a first set of characteristics of a venue at a first time instance; receiving a plurality of signals from a plurality of hardware sensors at a second time instance; determining a second set of characteristics of the venue based on the plurality of signals, wherein the first set of characteristics of the venue and the second set of characteristics of the venue comprise information about at least one user associated with the venue; comparing the first set of characteristics of the venue and the second set of characteristics of the venue; determining, using a hardware processor, whether the social event is in progress based on the comparison; and in response to determining that the social event is in progress, automatically creating an atmosphere suited to the social event.

### CROSS-REFERENCE TO RELATED APPLICATION

This application is a continuation of U.S. patent application Ser. No. 13/804,130, filed Mar. 14, 2013, which is incorporated by reference herein in its entirety.

### TECHNICAL FIELD

Methods, systems and media for creating an atmosphere suited to a social event are provided.

### BACKGROUND

Media consumption can depend on the context of the situation in which media is consumed. For example, a person may want to playback different media content in a private or social setting. The person may want to share photos, watch video clips, and interact with other people when participating in a social event (e.g., a party). Accordingly, an intelligent system for automatic social event detection and party-mode atmosphere creation is desirable.

### SUMMARY

Methods, systems and media for creating an atmosphere suited to a social event are provided.

In accordance with some implementations of the disclosed subject matter, methods for creating an atmosphere suited to a social event are provided, the methods comprising: determining a first set of characteristics of a venue at a first time instance; receiving a plurality of signals from a plurality of hardware sensors at a second time instance; determining a second set of characteristics of the venue based on the plurality of signals, wherein the first set of characteristics of the venue and the second set of characteristics of the venue comprise information about at least one user associated with the venue; comparing the first set of characteristics of the venue and the second set of characteristics of the venue; determining, using a hardware processor, whether the social event is in progress based on the comparison; and in response to determining that the social event is in progress, automatically creating an atmosphere suited to the social event.

In accordance with some implementations of the disclosed subject matter, systems for creating an atmosphere suited to a social event are provided, the systems comprising: at least one hardware processor that is configured to: determine a first set of characteristics of a venue at a first time instance; receive a plurality of signals from a plurality of hardware sensors at a second time instance; determine a second set of characteristics of the venue based on the plurality of signals, wherein the first set of characteristics of the venue and the second set of characteristics of the venue comprise information about at least one user associated with the venue; compare the first set of characteristics of the venue and the second set of characteristics of the venue; determine whether the social event is in progress based on the comparison; and in response to determining that the social event is in progress, automatically create an atmosphere suited to the social event.

In accordance with some implementations of the disclosed subject matter, non-transitory computer-readable media containing computer-executable instructions that, when executed by a processor, cause the processor to perform a method for automatically creating an atmosphere suited to a social event, the method comprising: determining a first set of characteristics of a venue at a first time instance; receiving a plurality of signals from a plurality of hardware sensors at a second time instance; determining a second set of characteristics of the venue based on the plurality of signals, wherein the first set of characteristics of the venue and the second set of characteristics of the venue comprise information about at least one user associated with the venue; comparing the first set of characteristics of the venue and the second set of characteristics of the venue; determining whether the social event is in progress based on the comparison; and in response to determining that the social event is in progress, automatically creating an atmosphere suited to the social event.

In accordance with some implementations of the disclosed subject matter, systems for creating an atmosphere suited to a social event are provided, the systems comprising: means for determining a first set of characteristics of a venue at a first time instance; means for receiving a plurality of signals from a plurality of hardware sensors at a second time instance; means for determining a second set of characteristics of the venue based on the plurality of signals, wherein the first set of characteristics of the venue and the second set of characteristics of the venue comprise information about at least one user associated with the venue; means for comparing the first set of characteristics of the venue and the second set of characteristics of the venue; means for determining whether the social event is in progress based on the comparison; and means for creating an atmosphere suited to the social event in response to determining that the social event is in progress.

In some implementations, the first set of characteristics of the venue includes a first number of people in the venue and the second set of characteristics of the venue includes a second number of people in the venue.

In some implementations, the systems further comprise means for determining that the social event is in progress when the second number of people in the venue is greater than the first number of people in the venue.

In some implementations, the first set of characteristics of the venue includes a first number of user devices in the venue and the second set of characteristics of the venue includes a second number of user devices in the venue.

In some implementations, the systems further comprise means for determining that the social event is in progress when the second number of user devices in the venue is greater than the first number of user devices in the venue.

In some implementations, the plurality of hardware sensors comprises at least one of a camera, a microphone, and a network sensor.

In some implementations, the systems further comprise means for displaying a party-mode user interface.

In some implementations, the systems further comprise means for generating a playlist of media content based on a general mood in the venue.

### BRIEF DESCRIPTION OF THE DRAWINGS

Various objects, features, and advantages of the disclosed subject matter can be more fully appreciated with reference to the following detailed description of the disclosed subject matter when considered in connection with the following drawings, in which like reference numerals identify like elements.

FIG. 1 is a flow chart of an example of a process for creating an atmosphere suited to a social event in accordance with some implementations of the disclosed subject matter.

FIG. 2 is an example of a venue in accordance with some implementations of the disclosed subject matter.

FIG. 3 is an example of a user interface in accordance with some implementations of the disclosed subject matter.

FIG. 4 is an example of a user device on which a request for geolocation is displayed in accordance with some implementations of the disclosed subject matter.

FIG. 5 is an example of a user device on which a vote menu is displayed in accordance with some implementations of the disclosed subject matter.

FIG. 6 is an example of a system for creating an atmosphere suited to a social event in accordance with some implementations of the disclosed subject matter.

### DETAILED DESCRIPTION

In accordance with various implementations, as described in more detail below, mechanisms for creating an atmosphere suited to a social event are provided. These mechanisms can be used to automatically detect a social event taking place in a venue and render media content suitable to the social event.

In some implementations, a set of benchmark characteristics of a venue can be learned at a first time instant. For example, when a social event is not being held in the venue, the number of people in the venue can be determined using a plurality of imaging and audio sensors. As another example, when a social event is not being held in the venue, the number of user devices and the type of user devices in the venue can be determined using multiple network sensors. Additionally, the set of benchmark characteristics of the venue can be stored in a storage device. At a second time instant, a set of updated characteristics of the venue can be determined. For example, an updated number of people or user devices in the venue can be determined at a time instant that is different from the first time instant. A social event can then be detected based on the benchmark characteristics of the venue and the updated characteristics of the venue. For example, a social event can be detected when the updated number of people in the venue exceeds the benchmark number of people in the venue. Upon detection of a social event, an atmosphere suited to the social event can be generated based on preferences and/or the mood of the participants of the social event. For example, a party-mode user interface can be displayed on a display device to enable the participants to interact with each other. As another example, media content can be played at an appropriate volume to encourage a lively atmosphere.

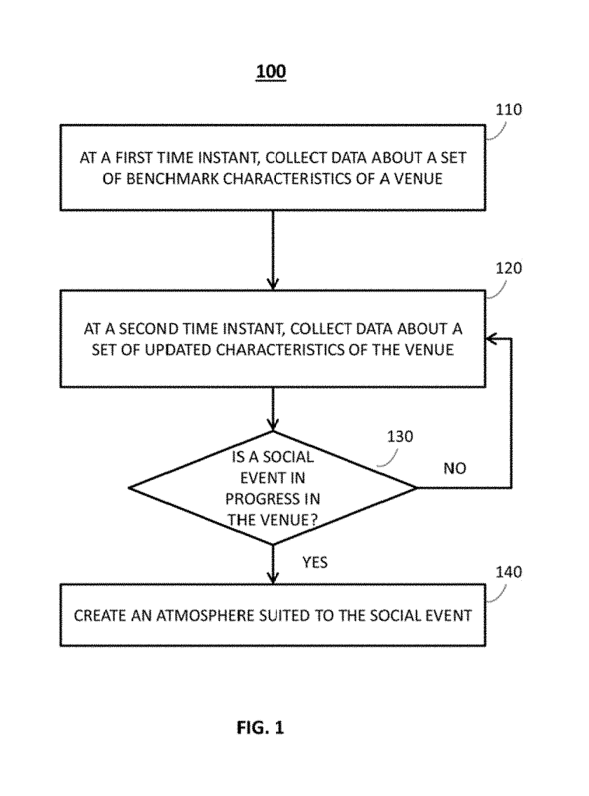

Turning to FIG. 1, a flow chart of an example of a process 100 for creating an atmosphere suited to a social event in accordance with some implementations of the disclosed subject matter is shown.

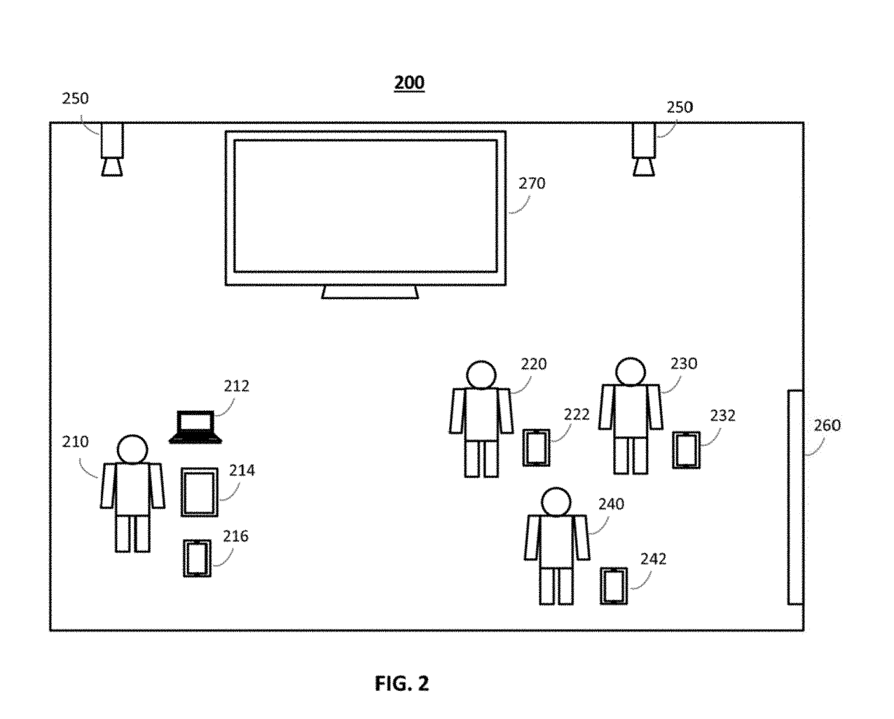

Process 100 can begin by collecting data about a set of benchmark characteristics of a venue at a first time instant at 110. For example, process 100 can collect data about people present in a venue when a social event is not being held in the venue. In a more particular example, as illustrated in FIG. 2, process 100 can detect the presence of host 210 in venue 200 when no social event is being held in venue 200. Process 100 can then determine the benchmark number of people in venue 200 at this time instant (i.e., one in the example).

In some implementations, one or more suitable sensors can be used to detect the presence of people in a venue, the number of people in a venue, etc. For example, as illustrated in FIG. 2, process 100 can determine the presence of people and the number of people in venue 200 based on signals received from one or more sensors 250. In a more particular example, sensors 250 can include one or more photoelectric sensors. In some implementations, one or more photoelectric sensors can be installed at the entrance 260 of venue 200. Each of the photoelectric sensors can comprise a photoelectric cell that can provide a beam (e.g., an infrared beam). As a person enters entrance 260, the beam is temporarily interrupted. The photoelectric sensors can count the number of people that have entered into venue 200 based on the number of interruptions.

In another more particular example, sensors 250 can include one or more thermal imaging sensors or infrared sensors. For example, a thermal imaging sensor can be mounted on the ceiling above a passageway. The thermal imaging sensor can apply thermal imaging technology and use heat recognition to gather information about the size, placement, direction and stopping of an object beneath. The number of people in the venue can then be determined based on the body heat information gathered by the thermal imaging sensor.

In another more particular example, sensors 250 can include one or more cameras. The cameras can be of any suitable type and arranged in any suitable manner. For example, each of the cameras can have a field of view that covers a portion of the venue. More particularly, for example, each of the cameras can have an overhead field of view. The cameras can produce image data including still images and moving images of the venue. Process 100 can analyze the image data and detect the presence of one or more persons in the image data. Process 100 can then track the persons detected in the image data using a suitable object tracking algorithm and count the number of people in the image data accordingly. It should be noted that any suitable object detection and tracking method can be used to count the number of people in a venue. For example, a person can be identified in the image data using any suitable image-based face recognition method, such as the OKAO VISION face detector available from OMRON CORPORATION of Kyoto, Japan. After a person is identified in the image data, any suitable tracking algorithm can be used to track the person, such as blob tracking, kernel-based tracking, contour tracking, visual feature matching, etc. Additionally or alternatively, process 100 can determine a set of facial features for each person detected in the image data. In a more particular example, as illustrated in FIG. 2, process 100 can extract a set of facial features of host 210 from the image data and store the extracted facial features as benchmark facial features in a suitable storage device.

In another more particular example, sensors 250 can include one or more occupancy sensors that can detect occupancy of a venue by people. For example, the occupancy sensors can detect motions of people in the venue. Process 100 can then determine the number of people in the venue based on the detected motions.

In another more particular example, sensors 250 can include one or more vibration sensors or pressure sensors. In some implementations, one or more vibration sensors can be placed on the floor of the venue. The vibration sensors or pressure sensors can measure the vibration or the force produced by a person's footsteps and detect the presence of people in the venue and their movement within the venue.

In another more particular example, sensors 250 can include one or more audio sensors. In some implementations, when a social event is not being held in the venue, process 100 can receive audio data representing the voice of a person in the venue using a suitable audio sensor. Process 100 can also store an audio file containing the audio data as benchmark audio data in a suitable storage device. Additionally or alternatively, process 100 can extract multiple acoustic features from the audio data and store the acoustic features as benchmark audio data in the storage device. In some implementations, process 100 can also process the audio data and determine the number of people in venue 200 using a suitable voice recognition algorithm.

In another example, at the first time instant, process 100 can collect data about the user devices in the venue. More particularly, for example, process 100 can determine the number of user devices, the type of user devices, etc. in the venue. In some implementations, process 100 can detect a communication signal transmitted by a user device. Process 100 can then identify the user device based on the signal. For example, a user device can be capable of transmitting communication signals containing identification information at regular intervals using a wireless technology and/or a protocol, such as BLUETOOTH, NFC, WIFI, GSM, GPRS, UMTS, HSDPA, CDMA, etc. Process 100 can detect multiple communication signals in a predetermined period. Process 100 can then count the number of different communication signals based on the identification information contained in these communication signals. In a more particular example, one or more network sensors can conduct a scan of all the existing BLUETOOTH signals and NFC signals within the venue. Process 100 can identify the user devices transmitting the BLUETOOTH signals or the NFC signals without paring the user devices. In another more particular example, one or more network sensors can monitor and analyze the mobile phone network activity and/or mobile data network activity taking place during a certain period of time.

In a more particular example, as illustrated in FIG. 2, host 210 can be associated with user devices 212, 214, and 216. When a social event is not being held in venue 200, process 100 can detect the presence of user devices 212, 214, and 216. Process 100 can then determine that the benchmark number of user devices in venue 200 (i.e., three or any other suitable number). Additionally or alternatively, process 100 can identify the types of user devices 212, 214, and 216 as being a laptop computer, a tablet computer, and a mobile phone, respectively. In some implementations, process 100 can store the benchmark number of the user devices and the benchmark types of the user devices in a suitable storage device.

In yet another example, process 100 can collect data about ambient sounds in a venue when a social event is not being held in the venue. For example, process 100 can receive audio data from one or more audio sensors that are installed in the venue. Process 100 can then determine a benchmark ambient noise level based on the audio signals.

Next, at 120, process 100 can collect data about a set of updated characteristics of the venue at a second time instant. For example, at a second time instant that is different from the first time instant, process 100 can collect data about the people in the venue. In a more particular example, as illustrated in FIG. 2, process 100 can detect the presence of guests 220, 230, and 240 in addition to host 210 in venue 200. Process 100 can then determine that the updated number of people in venue 200 at this time instant (i.e., four in the example).

Similar to 110 of FIG. 1, at the second time instant, process 100 can determine the presence of people and the number of people in the venue using one or more suitable sensors, such as photoelectric sensors, thermal imaging sensors, infrared sensors, cameras, vibration sensors, pressure sensors, occupancy sensors, audio sensors, etc. For example, process 100 can receive video data including still images and moving images from one or more suitable cameras. Process 100 can then detect one or more people present in the image data using a suitable face recognition algorithm. Process 100 can also track the persons detected in the image data and count the number of people in the image data using a suitable object tracking algorithm. Additionally or alternatively, process 100 can extract a set of a set of facial features for each person detected in the venue. Process 100 can also compare the set of facial features with the benchmark facial features to distinguish a guest from a host.

As another example, process 100 can receive audio data from one or more audio sensors arranged in the venue. Process 100 can then process the audio data and determine the number of people in venue 200 using a suitable voice recognition algorithm. More particular, for example, process 100 can identify the voice of host 210 based on the benchmark audio data stored in the storage device. Process 100 can also recognize different speakers by their voices contained in the audio data.

At the second time instant, process 100 can also collect data about the user devices in the venue. For example, similar to 110 of FIG. 1, process 100 can determine the number of user devices, the type of user devices, etc. in the venue. More particularly, for example, process 100 can detect a communication signal transmitted by a user device and identify different communication signals based on the identification contained in multiple communication signals. In a more particular example, as illustrated in FIG. 2, process 100 can detect the presence of user devices 212, 214, 216, 222, 232, and 242 in venue 200. Process 100 can also identify that user devices 212, 214, and 216 are associated with host 210 based on the benchmark characteristics of venue 200 stored in the storage device. Additionally or alternatively, process 100 can identify that user devices 222, 232, and 242 are three mobile phones that are not associated with host 210. In some implementations, process 100 can generate a list of the type of the user devices in a venue, the identification of the user devices, etc. and store the list in a storage module.

At the second time instant, process 100 can also collect data about the ambient noises in the venue. More particular, for example, process 100 can determine an updated ambient noise level in the venue using a suitable audio sensor.

Next, at 130, process 100 can determine whether a social event is in progress in the venue. For example, process 100 can make such determination by comparing the benchmark characteristics of the venue and the updated characteristics of the venue. More particularly, for example, process 100 can determine that a social event is in progress in response to detecting an increase in the number of people, the number of user devices, etc. in the venue. In some implementations, process 100 can determine that a social event is in progress when the updated number of people in the venue is greater than the benchmark number of people in the venue. Additionally or alternatively, process 100 can determine that a social event is in progress when the number of user devices in a venue exceeds the benchmark number of user devices in the venue. For example, as illustrated in FIG. 2, process 100 can detect the presence of user devices 222, 232, and 242 in addition to benchmark user devices 212, 214, and 216. Process 100 can then determine that a social event is in progress based on the increase in the number of user devices in venue 200. In some implementations, process 100 can determine that a social event is in progress when an increase in the number of people or the number of user devices in the venue exceeds a predetermined threshold. It should be noted that any suitable threshold can be used to make such determination(s). For example, the predetermined threshold can be the number of guests that are invited to the social event. In a more particular example, as illustrated in FIG. 2, the threshold can be set as three when host 210 intends to invite three guests to a social event. Process 100 can determine that a social event is being held in venue 200 upon detecting the presence of four persons in venue 200.

Additionally or alternatively, process 100 can determine whether a social event is in progress in the venue based on public information or private information about the host of the social event. Examples of such information can include calendar information, appointments, event pages, contacts, mobile phone messaging history, information available on a social networking site, and/or any other suitable information.

In response to determining that a social event is not in progress, process 100 can loop back to 120. Alternatively, in response to determining that a social event is in progress, process 100 can create an atmosphere suited to the social event at 140. For example, in response to determining that a social event is in progress, process 100 can present a user interface that is suited to the social event. In some implementations, a party-mode user interface can be displayed on display device 270 (FIG. 2). Additionally or alternatively, a party-mode user interface can be displayed on a screen of a user device.

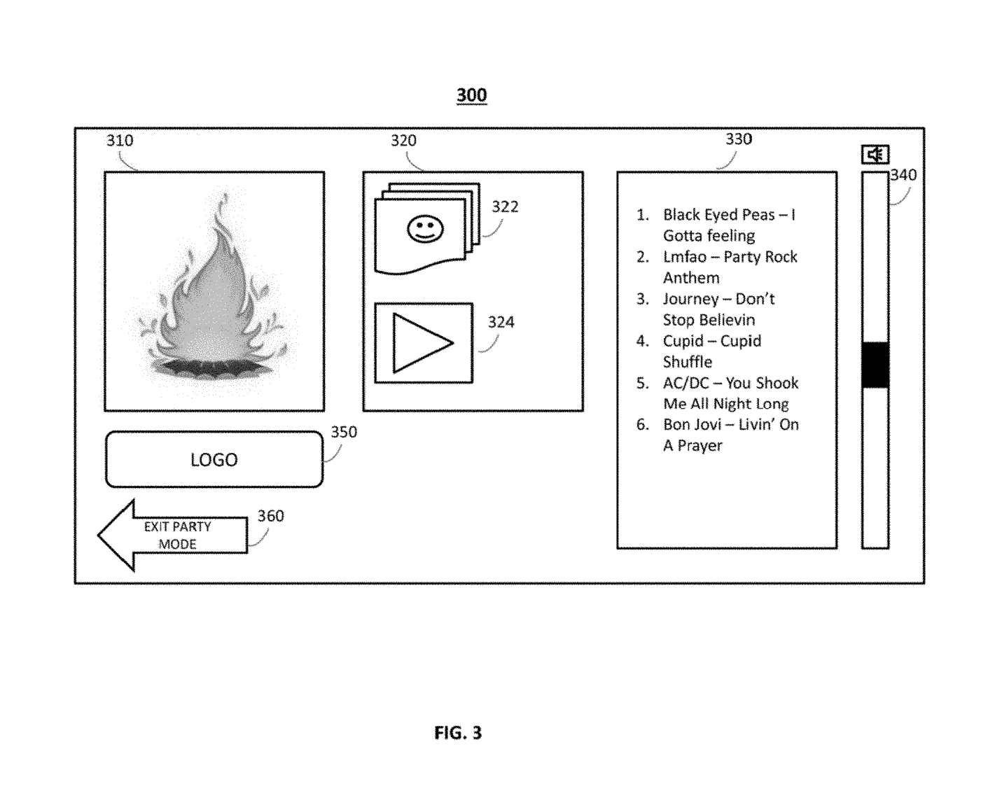

More particularly, for example, process 100 can display a party-mode user interface 300 as illustrated in FIG. 3. User interface 300 can include theme presentation area 310, interactive application presentation area 320, media content presentation area 330, volume bar 340, logo 350, and exit button 360.

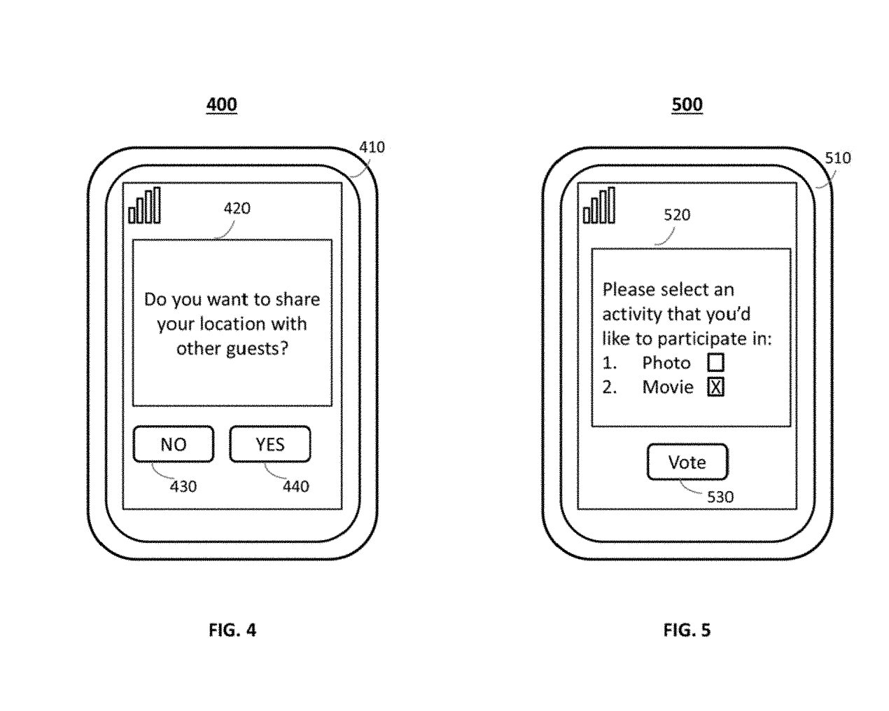

Process 100 can present in area 310 and/or on a separate display a theme suited to the social event. For example, process 100 can select an appropriate application based on the location of the venue, calendar information, weather information, information available on the host's social network pages, etc. More particularly, for example, process 100 can determine that the social event being held in the venue is a Christmas party by checking calendar information. Process 100 can then run a fireplace application and present a fireplace in area 310 and/or on a separate display accordingly. Additionally or alternatively, process 100 can create sound effects that are suited to the theme displayed in area 310 and play those sound effects on an audio system. In some implementations, process 100 can determine the location of a venue based on geolocation information received from a user device present in the venue. For example, process 100 can send to a user device a request for permission to share its geolocation information. In a more particular example, as illustrated in FIG. 4, user device 400 can comprise a display 410 on which a request 420 is displayed. A user can approve the request by pressing “YES” button 440. Alternatively, the user can reject the request by pressing “NO” button 430.

Turning back to FIG. 3, process 100 can present a list of applications in interactive application presentation area 320. In accordance with some implementations, the participants of the social event can use the applications to interact with each other. For example, process 100 can present a photo gallery application 322 and a media player application 324. More particularly, for example, photo gallery application 322 can allow participants of a social event to take, browse, edit, and share pictures or videos. Media player applications 326 can playback multimedia files, such as audio and video files, on a suitable audio and/or video system. In some implementations, a participant of the social event can select an interactive application by touching a portion of interactive application presentation area 320 that corresponds to the interactive application. In some implementations, an event participant can select an interactive application displayed in area 320 using a user device.

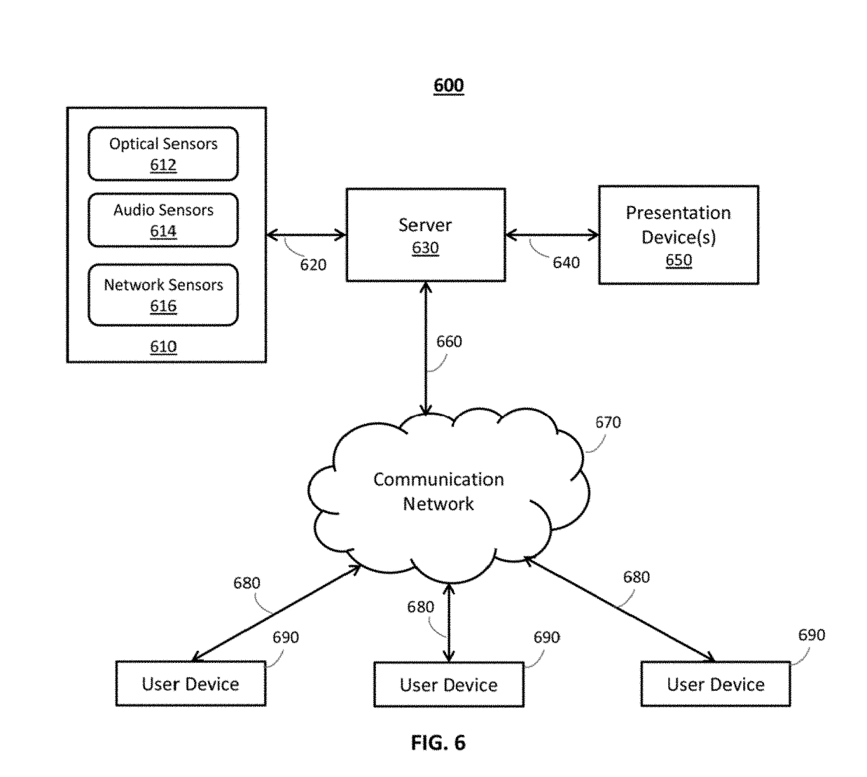

For example, as illustrated in FIG. 5, a user device 500 can comprise a display 510 on which a voting menu 520 can be displayed. In some implementations, voting menu 520 can include the names of the interactive applications that are displayed on user interface 300. The participate can select a desirable interactive application by touching the name of the interactive application option on a touch-screen display. Alternatively or additionally, a participant can select an interactive application by highlighting the interactive application and pressing vote button 530. In some implementations, process 100 can suggest an interactive application based on the type of a user device. For example, upon determining that a user device is a tablet computer, process 100 can suggest an interactive application suitable to the tablet computer.

Turning back to FIG. 3, in media content presentation area 330 of user interface 300, process 100 can present a playlist of media content, such as sound tracks, video clips, etc. For example, process 100 can retrieve a playlist stored in a storage device. More particularly, for example, a playlist of media content used in a previous social event can be stored in a storage device and used in a later social event. As another example, process 100 can generate a playlist of media content based on the participants of the social event. In a more particular example, process 100 can detect the general mood of the participants and generate a playlist of media content based on the general mood. For example, in some implementations, process 100 can: receive audio data and/or video data from multiple sensors arranged in a venue; analyze the audio data and the video data and determine the mood of the participants in the venue using suitable face and voice recognition algorithms; and generate a playlist of media content that is suited to the detected mood. In another more particular example, process 100 can detect the language spoken by the participants in the venue using a voice recognition algorithm. Process 100 can then generate a list of media content suited to the detected language. In yet another more particular example, process 100 can gather data about the participants' preferences and generate a playlist of media content based on the participants' preferences. For example, a participant can send a message to process 100 using a user device to suggest a playlist of media content that the user wants to playback. Process 100 can receive multiple messages containing suggested playlists from multiple participants. Process 100 can then generate a playlists of media content based on the received messages.

Once a playlist is generated as described above, process 100 can display the playlist in media content presentation area 330 of user interface 300. Alternatively or additionally, the playlist can be displayed on a screen of a user device. In some implementations, an event participant can select a piece of media content presented in the playlist by touching the piece of media content on user interface 300. Alternatively, the participant can select a piece of media content and send a vote to process 100 using a user device. Process 100 can receive multiple votes from multiple participants and rank the media content included in the playlist based on the received votes. Process 100 can then determine the play order of the media content accordingly.

Turning back to FIG. 3, volume bar 340 of user interface 300 can indicate the sound volume of media content being played. In some implementations, process 100 can automatically adjust the sound volume based on the ambient noise level in the venue. Alternatively or additionally, a participant can adjust sound volume by touching and dragging the volume bar or using his finger on a user device.

Logo 350 can be any suitable logo of any suitable provider of user interface 300. In accordance with some implementations, logo 350 can include any suitable text, graphics, images, video, etc. Exit button 360 can be used to exit the party-mode user interface 300.

Turning to FIG. 6, a generalized block diagram of an example of a system 600 for creating an atmosphere suited to a social event in accordance with some implementations of the disclosed subject matter is shown. As illustrated, system 600 can include one or more sensors 610, one or more servers 630, presentation device(s) 650, a communication network 670, one or more user devices 690, and communication links 620, 640, 660, and 680. In some implementations, process 100 as illustrated in FIG. 1 can be implemented in system 600. For example, process 100 can run on server 630 of system 600.

Sensors 610 can include one or more optical sensors 612, audio sensors 614, and network sensors 616. Optical sensor 612 can be any suitable sensor that is capable of obtaining optical data, such as an imaging sensor, a photoelectric sensor, a thermal imaging sensor, an infrared sensor, a camera, etc. In some implementations, optical sensors 612 can be three-dimensional capable. Audio sensor 614 can include any suitable sensor that is capable of obtaining audio data, such as a microphone, a sound level meter, etc. Network sensor 616 can be any suitable sensor that is capable of detecting signals transmitted using a wireless technology and/or a communication protocol, such as BLUETOOTH, NFC, WIFI, GSM, GPRS, UMTS, HSDPA, CDMA, etc. Sensors 610 can be connected by one or more communication links 620 to a server 630.

Server 630 can be any suitable server for creating an atmosphere suited to a social event, such as a hardware processor, a computer, a data processing device, or a combination of such devices. More particularly, for example, process 100 as illustrated in FIG. 1 can run on server 630. Server 630 can be connected by one or more communication links 640 to presentation device(s) 650.

Presentation device(s) 650 can include and/or be a display device, a playback device, a lighting device, and/or any other suitable device that can be used to create an atmosphere suited to a social event. For example, presentation device(s) 650 can be a monitor, a television, a liquid crystal display (LCD) for a mobile device, a three-dimensional display, a touchscreen, a simulated touch screen, a gaming system (e.g., X-BOX, PLAYSTATION, or GAMECUBE), a portable DVD player, a portable gaming device, a mobile phone, a personal digital assistant (PDA), a music player (e.g., a MP3 player), a tablet, a laptop computer, a desktop computer, an appliance display (e.g., such as a display on a refrigerator), or any other suitable fixed device or portable device.

Server 630 can be also connected by one or more communication links 660 to communication network 670. Communication network 670 can be any suitable computer network such as the Internet, an intranet, a wide-area network (“WAN”), a local-area network (“LAN”), a wireless network, a digital subscriber line (“DSL”) network, a frame relay network, an asynchronous transfer mode (“ATM”) network, a virtual private network (“VPN”), a satellite network, a mobile phone network, a mobile data network, and/or any other suitable communication network, or any combination of any of such networks. Communication network 670 can be connected by one or more communication links 680 to one or more user devices 690.

User devices 690 can include a mobile phone, a tablet computer, a laptop computer, a desktop computer, a personal data assistant (PDA), a portable email device, a game console, a remote control, a voice recognition system, a gesture recognition system, and/or any other suitable device. Although three user devices 690 are shown in FIG. 6 to avoid over-complicating the drawing, any suitable number of these devices, and suitable types of these devices, can be used in some implementations.

Each of sensors 610, servers 630, presentation device(s) 650, and user device 690 can include and/or be any of a general purpose device such as a computer or a special purpose device such as a client, a server, etc. Any of these general or special purpose devices can include any suitable components such as a hardware processor (which can be a microprocessor, digital signal processor, a controller, etc.), memory, communication interfaces, display controllers, input devices, etc. For example, each of sensors 610, servers 630, presentation device(s) 650, and user device 690 can be implemented as or include a personal computer, a tablet computing device, a personal data assistant (PDA), a portable email device, a multimedia terminal, a mobile telephone, a gaming device, a set-top box, a television, etc. Moreover, each of sensors 610, servers 630, presentation device(s) 650, and user device 690 can comprise a storage device, which can include a hard drive, a digital video recorder, a solid state storage device, a gaming console, a removable storage device, and/or any other suitable storage device.

Communication links 620, 640, 660, and 680 can be any suitable communication links, such as network links, dial-up links, wireless links, hard-wired links, any other suitable communication links, or a combination of such links.

User devices 690 and server 630 can be located at any suitable location. Each of the sensors 610, servers 630, presentation device(s) 650, and user devices 690 can be implemented as a stand-alone device or integrated with other components of system 600.

In some implementations, any suitable computer readable media can be used for storing instructions for performing the processes described herein. For example, in some implementations, computer readable media can be transitory or non-transitory. For example, non-transitory computer readable media can include media such as magnetic media (such as hard disks, floppy disks, etc.), optical media (such as compact discs, digital video discs, Blu-ray discs, etc.), semiconductor media (such as flash memory, electrically programmable read only memory (EPROM), electrically erasable programmable read only memory (EEPROM), etc.), any suitable media that is not fleeting or devoid of any semblance of permanence during transmission, and/or any suitable tangible media. As another example, transitory computer readable media can include signals on networks, in wires, conductors, optical fibers, circuits, any suitable media that is fleeting and devoid of any semblance of permanence during transmission, and/or any suitable intangible media.

In accordance with some implementations, the mechanisms for creating an atmosphere suited to a social event can include an application program interface (API). For example, the API can be resident in the memory of server 630 or user device 690.

In situations in which the systems discussed here collect personal information about users, or may make use of personal information, the users may be provided with an opportunity to control whether programs or features collect user information (e.g., information about a user's social network, social actions or activities, profession, a user's preferences, or a user's current location), and/or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a content server.

Accordingly, methods, systems, and media for creating an atmosphere suited to a social event are provided.

Although the disclosed subject matter has been described and illustrated in the foregoing illustrative implementations, it is understood that the present disclosure has been made only by way of example, and that numerous changes in the details of implementation of the disclosed subject matter can be made without departing from the spirit and scope of the disclosed subject matter, which is limited only by the claims that follow. Features of the disclosed implementations can be combined and rearranged in various ways.

What is claimed is:

1. A method for presenting content, comprising:
determining, at a first time instance, a first set of characteristics of a location;
determining, at a second time instance, a second set of characteristics of the location, wherein the second set of characteristics comprises a detection of a presence of a user device at the location, and wherein the user device was not present at the location at the first time instance;
based on the presence of the user device at the second time instance, retrieving a previously presented playlist of a plurality of media content items; and
causing the playlist of media content items to be presented using a playback device associated with the location.

2. The method of claim 1, further comprising receiving geolocation information from the user device.

3. The method of claim 1, wherein the detection of the presence of the user device at the location is based on a detection of communication signals transmitted by the user device at the location at the second time instance.

4. The method of claim 1, wherein the second set of characteristics includes audio data recorded at the location at the second time instance, and wherein the method further comprises recognizing a voice of a user associated with the location based on speech in the audio data.

5. The method of claim 1, further comprising causing a user interface associated with the playback device to be presented on the user device, wherein the user interface includes user interface controls for modifying playback of media content items included in the playlist of media content items.

6. A system for presenting content, the system comprising:
a memory; and
a hardware processor coupled to the memory that is configured to:
determine, at a first time instance, a first set of characteristics of a location;
determine, at a second time instance, a second set of characteristics of the location, wherein the second set of characteristics comprises a detection of a presence of a user device at the location, and wherein the user device was not present at the location at the first time instance;
based on the presence of the user device at the second time instance, retrieve a previously presented playlist of a plurality of media content items; and
cause the playlist of media content items to be presented using a playback device associated with the location.

7. The system of claim 6, wherein the hardware processor is further configured to receive geolocation information from the user device.

8. The system of claim 6, wherein the detection of the presence of the user device at the location is based on a detection of communication signals transmitted by the user device at the location at the second time instance.

9. The system of claim 6, wherein the second set of characteristics includes audio data recorded at the location at the second time instance, and wherein the method further comprises recognizing a voice of a user associated with the location based on speech in the audio data.

10. The system of claim 6, wherein the hardware processor is further configured to cause a user interface associated with the playback device to be presented on the user device, wherein the user interface includes user interface controls for modifying playback of media content items included in the playlist of media content items.

11. A non-transitory computer-readable method containing computer executable instructions that, when executed, cause a hardware processor to perform a method for presenting content, the method comprising:
determining, at a first time instance, a first set of characteristics of a location;
determining, at a second time instance, a second set of characteristics of the location, wherein the second set of characteristics comprises a detection of a presence of a user device at the location, and wherein the user device was not present at the location at the first time instance;
based on the presence of the user device at the second time instance, retrieving a previously presented playlist of a plurality of media content items; and
causing the playlist of media content items to be presented using a playback device associated with the location.

12. The non-transitory computer-readable medium of claim 11, wherein the method further comprises receiving geolocation information from the user device.

13. The non-transitory computer-readable medium of claim 11, wherein the detection of the presence of the user device at the location is based on a detection of communication signals transmitted by the user device at the location at the second time instance.

14. The non-transitory computer-readable medium of claim 11, wherein the second set of characteristics includes audio data recorded at the location at the second time instance, and wherein the method further comprises recognizing a voice of a user associated with the location based on speech in the audio data.

15. The non-transitory computer-readable medium of claim 11, wherein the method further comprises causing a user interface associated with the playback device to be presented on the user device, wherein the user interface includes user interface controls for modifying playback of media content items included in the playlist of media content items.
